(19) United States
(12) Patent Application Publication
(10) Pub. No.: US 2013/0149987 A1
(43) Pub. Date: Jun. 13, 2013

(54) APPARATUS AND METHOD FOR DETERMINING AND ROUTING EMERGENCY COMMUNICATIONS

(71) Applicants: Ching-Wen CHENG, Tainan (TW); Jen-Shun Yang, Hsinchu (TW); Stephan Gleixner, Hsinchu (TW); Shubhranshu Singh, Hsinchu (TW); Kuei-Li Huang, Kaohsiung (TW)

(72) Inventors: Ching-Wen CHENG, Tainan (TW); Jen-Shun Yang, Hsinchu (TW); Stephan Gleixner, Hsinchu (TW); Shubhranshu Singh, Hsinchu (TW); Kuei-Li Huang, Kaohsiung (TW)

(73) Assignee: INDUSTRIAL TECHNOLOGY RESEARCH INSTITUTE, Hsinchu (TW)

(21) Appl. No.: 13/433,858

(22) Filed: Mar. 29, 2012

(30) Foreign Application Priority Data
Dec. 8, 2011 (TW) 100145361

(51) Int. Cl. H04W 4/22

(52) U.S. Cl. 455/404.1

(57) ABSTRACT

A determining and routing apparatus uses an emergency event pre-processor (EEPP) to decide a machine-based emergency event request and route a corresponding emergency message to at least one proper emergency reaction center (emRC). For each emergency event request from one or more signal sending devices, the EEPP decides the emergency event request, analyzes at least one machine-based emergency event service type set in a parameter in accordance with the request, selects at least one emRC to process the machine-based emergency event service type from one or more emRCs, and decides at least one routing path for transmitting the corresponding emergency message. At least one mapping lists maintain the mapping information between the machine-based emergency event service types and the emRCs.

### CROSS-REFERENCE TO RELATED APPLICATION

The present application is based on, and claims priority from, Taiwan Application No. 100145361, filed Dec. 8, 2011, the disclosure of which is hereby incorporated by reference herein in its entirety.

### TECHNICAL FIELD

The present disclosure generally relates to an apparatus and method for determining and routing emergency communications.

### BACKGROUND

Emergency communications has an exclusive right of communications resources. Once the system is in need of that emergency events are to be transmitted, other communication procedures with normal priorities or low priorities will be delayed in order to release their communication resources for the emergency communications usage of the emergency events. Types of network infrastructure for warning notifications may use, for example, the aggregated connection topology as shown in FIG. 1A or the direct connection topology as shown in FIG. 1B.

In FIG. 1A, after each warning notification provided by a warning notification provider (WNP) has been proceeded priority control and scheduled by an aggregation agency 110, the aggregation agency 110 then connects and notifies a core network operator 120. In FIG. 1B, each warning notification provider directly connects to a core network, and each provided warning notification is proceeded priority control and scheduled by the core network operator according to the service contract between the core network operator and the warning notification provider (WNP).

FIG. 2 shows a schematic view of an exemplary architecture for a current third generation partnership program (3GPP) emergency communication network. The 3GPP emergency communications network architecture 200 provides needed network architectures for emergency communications, and responsible functions of the network entities in the network architectures. Wherein, an emergency sender such as a MTC device is responsible for detecting and issuing an emergency notification, a core network 220 is responsible for arranging corresponding emergency communications resources for each of the MTC devices and setting up an emergency communications connection of the MTC device to an appropriate emergency reaction center (emRC), such as an emergency server 210.

Under the current 3GPP communication network architecture, in order to determine the emergency access point name (emAPN) of an emergency reaction center, and set up a connection and route an emergency event to the emRC, each general packet radio service (GPRS) support node, i.e., the SGSN, of the core network needs to have an emergency service category value and corresponding information of the emAPN. The establishment of emergency communications may contain two procedures. One procedure is to determine the emergency service category value and decide the routing target of emergency communications resources. The other procedure is to set up an emergency connection to an emRC for the emergency message sender through an emergency priority or a high priority.

FIG. 3 shows a table describing the required specified emergency service category values for an existing 3GPP communications environment when a message sender issues an emergency notification. Each 3GPP communication network received the emergency notification determines the access point name (APN) of an emRC within the coverage governed by the 3GPP communication network. When the core network fails to identify the emergency services category value provided by the message sender, the core network will route the emergency event to a predetermined emRC within the coverage governed by the 3GPP communication network. The emergency notification sent by the message sender will be also routed to the predetermined emRC. In the exemplar of FIG. 3, bits 1 to 8 are used to distinguish different usages for the emergency service category values. When the message sender issues an emergency notification, a specified corresponding bit of the emergency service category value for the emergency notification will be set to 1. For bits 1 to 7, if two or more bits are set to 1 at the same time, then the processing order for the emergency service category value may be changed in accordance with the policy of communications network operators. But various combinations of bits 1 to 7 do not generate new functions of these emergency service category values. In other words, the message sender can only specify the emergency service category values shown in FIG. 3. And, the message sender cannot generate any new emergency category values other than the emergency service category values specified in the FIG. 3 by assigning multiple bits. Usually, bit 8 is preset to 0, representing blank, which is usually unused.

Under the architecture of emergency communication network of FIG. 2, each emergency service category value may correspond to one or more emergency configuration data (Em config data). FIG. 4 shows a schematic view describing a SGSN emergency configuration data. In the exemplar of FIG. 4, an emergency configuration data contains at least five fields, and description of each field. The information of five fields includes the emergency access point name (emAPN) of a 3GPP communication network that the SGSN also belong to, the emergency QoS profile, the emergency evolved assignment and retention priority (ARP), the emergency APN-maximum aggregated bit rate (AMBR), and the emergency packet data network gateway/gateway GPRS support node identity (PDN GW/GGSN Identity) of the 3GPP communication network that the SGSN also belong to. Description of these fields is as shown in FIG. 4. For example, emAPN is a label according to the domain name server (DNS) naming conventions describing the identity of the access point used for emergency bearers.

Machine-based communication services may provide a diversified service for various warning services, such as warnings for landslides, earthquakes, tsunamis, mine disaster, flood dike, hurricane, etc. Each service requires a specific server responsible for data interpretation and determining reaction methods. Existing emergency service category values are insufficient to provide machine-based emergency services. When the system fails to determine an emergency services category value, such as the case of speech-based emergency reaction and handling, the well-trained persons of the predetermined emRC may determine how to react based on the emergency conditions described by the user. And the SGSN/GGSN of the core network, that has received the emergency notification, may add location information to each individual emergency communication to enhance the processing efficiency of the emergency event. However, when existing communication networks process emergency events, some of the communication networks only use the data from the emRC predetermined by their communication networks themselves. While the senders may not be able to send voice warning messages due to the limited capability of the senders. The emRC that received the emergency notification is difficult to determine the meaning of the non-voice warning messages, and may miss important notification messages.

Under the current global broadband mobile network communication standard, machine-based emergency communication services are implemented on a home mobile operator network (home MON) where a user equipment (UE) registered. Once the registered UE leaves the home MON and enters into other MONs (known as visiting MONs), emergency communications fail to be routed to an appropriate emRC through these visiting MONs, thereby resulting in messages loss or data missing. So that timely notification and disaster reaction cannot be achieved.

Some literatures disclosed technologies for supporting and transmitting emergency information in wireless networks. For example, a technology of supporting emergency communications between a base station and an access point in a wireless local area network. Wherein, a mobile UE may connect to a particular base station with a specific emergency ID through the wireless local area network. Base stations making emergency calls are given precedence over other base stations. And base stations may utilize the wireless local area network for making emergency calls to public safety answering point (PSAP) by Voice over Internet Protocol (VoIP). But if the UE leaves the home MON and enters a visiting MON, the visiting MON fails to handle the specific emergency ID and also fails to contact a specific base station to set up a connection. Another technology is transmitting high priority data such as data of emergency call in a wireless network. Wherein, a packet switched (PS) emergency call may include multiple streams; and each stream has a destination IP address. The PS domain of the emergency calls may include such as IP multimedia sub-system (IMS), session initiation protocol (SIP), VoIP and so on. This technology uses different routing paths to route different streams to a packet switched answering point (PSAP), but does not mention the mechanism of the establishment of emergency with high priority connections. Also, if the UE leaves the home MON and enters a visiting MON, the visiting MON fails to set up high priority connections for each of the multiple streams.

Another technique utilizes of multiple communication networks for routing emergency messages, in order to enhance the robustness of home and business security systems. This technology uses a specific site controller which is responsible for choosing network for specific emergency services, and this feature is only available to the users registered in the home MON. Additional information, special paramedic support, etc. may be provided by intermediate network nodes. If the user leaves the home MON, then the services of the specific site controller cannot be obtained. Yet another technology sets a multiple emergency message types in wireless communication devices, and users may select needed emergency message types among the multiple emergency message types in the wireless communication devices. This technique pre-records the contents of a plurality of emergency messages being of different emergency message types. A default network address associates with each emergency message. The technology also utilizes an emergency request processing mechanism to set up and route emergency requests. The UE may contact a default network address by a normal call, and trigger the default network address to issue emergency requests from the default network address to the P SAP.

### SUMMARY

The exemplary embodiments of the present disclosure may provide a determining and routing apparatus and method for emergency communications.

One exemplary embodiment relates to a determining and routing apparatus for emergency communications, adapted to a network environment. The determining and routing apparatus comprises an emergency event pre-processor (EEPP), and the EEPP has a pre-processing element. For at least one emergency request issued by one or more senders, the pre-processing element determines the at least one emergency request, resolves at least one machine-based emergency service category value specified in a parameter according to the request, selects at least one emergency reaction center (emRC) for processing the at least one machine-based emergency service category value, and decides at least one routing path to transmit one or more corresponding emergency messages.

Another exemplary embodiment relates to a determining and routing method for emergency communications, adapted to a network environment. The method uses an emergency event pre-processor (EEPP) to process at least one emergency request issued by one or more senders. The processing by the EEPP comprises: determining the at least one emergency request; resolving at least one machine-based emergency service category value specified in a parameter according to the request; selecting at least one emRC for processing the at least one machine-based emergency service category value; and deciding at least one routing path to transmit one or more corresponding emergency messages.

The foregoing and other features and aspects of the disclosure will become better understood from a careful reading of a detailed description provided herein below with appropriate reference to the accompanying drawings.

### BRIEF DESCRIPTION OF THE DRAWINGS

FIG. 1A shows a schematic view of an aggregated connection topology of a network infrastructure for warning notifications.

FIG. 1B shows a schematic view of a direct connection topology of a network infrastructure for warning notifications.

FIG. 2 shows a schematic view of an exemplary architecture for a current third generation partnership program (3GPP) emergency communication network.

FIG. 3 shows a table describing the required specified emergency service category values when a message sender issues an emergency notification.

FIG. 4 shows a schematic view describing a SGSN emergency configuration data.

FIG. 5 shows a schematic view of utilizing a NAS Config MO parameter for setting additional information as the machine-based emergency services category values, according to an exemplary embodiment.

FIG. 6 shows a schematic view of a determining and routing apparatus for machine-based emergency communications, according to an exemplary embodiment.

FIG. 7 illustrates each field of a mapping list, according to an exemplary embodiment.

FIG. 8 shows a schematic view illustrating the EEPP is configured with an application level solution, according to an exemplary embodiment.

FIG. 9 shows a schematic view illustrating the EEPP is configured with a network switching entity solution, according to an exemplary embodiment.

FIG. 10 shows a schematic view illustrating the EEPP is configured with a network gateway entity solution, according to an exemplary embodiment.

FIG. 11 shows the operation of a method for determining and routing emergency communications, according to an exemplary embodiment.

FIG. 12 shows a machine-based emergency determining and routing procedure, when EEPP is configured with the application level solution, according to an exemplary embodiment.

FIG. 13 shows a machine-based emergency determining and routing procedure, when EEPP is configured with a network switching entity level solution, according to an exemplary embodiment.

FIG. 14 shows a machine-based emergency determining and routing procedure, when EEPP is configured with a network gateway entity level solution, according to an exemplary embodiment.

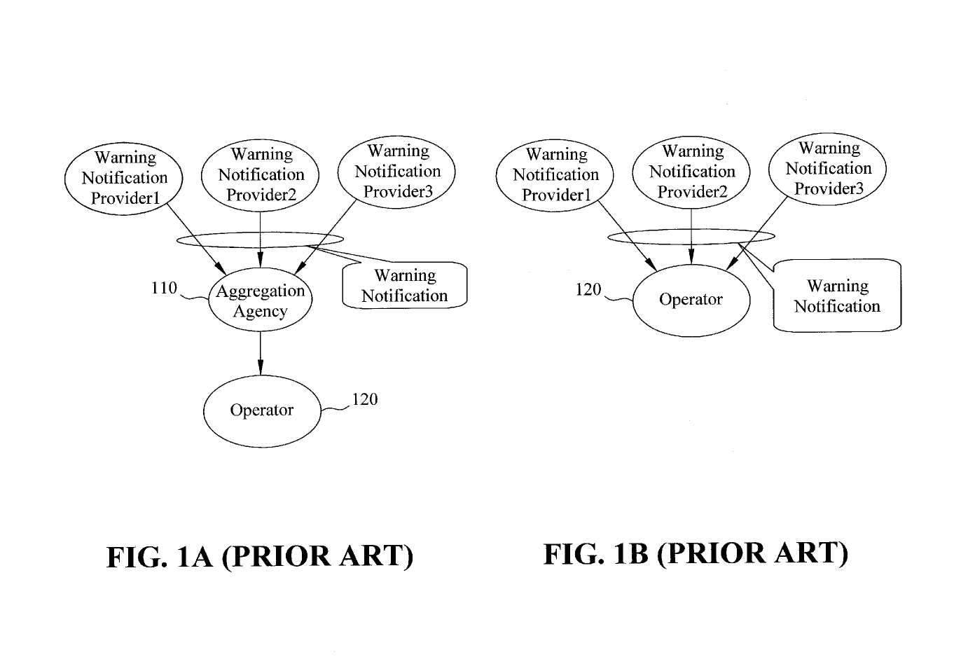

### DETAILED DESCRIPTION OF DISCLOSED EMBODIMENTS

The core techniques of machine-based communications focus on Wireless Sensing Network (WSN), Radio Frequency Identification (RFID), Machine to Machine (M2M) communications and so on. M2M communications is also referred as Machine Type communications (MTC). Machine-based monitoring for providing fast reaction and automatic notification services is one of machine-based communication applications.

As opposed to the current technology which often relies on human assistance, the present disclosure may automatically report and process the machine-based communication applicable to emergency so as to achieve the advantages of real-time timeliness and data integrity, and allow the machines to automatically decide and route the emergent events without human participation. The present disclosure may also enhance the detection and surveillance areas which are lack of manpower, as well as provide diverse services, such as, automatic control, severe environment monitoring, rapid alarm and report, goods/item tracking and remote medical care. In the present disclosure, the so-called machine-based sender may be, but not limited to, Internet communication device, mobile device, other devices with base station function, and so on.

The exemplary embodiments of the present disclosure may provide a routing mechanism for emergency communication. Regardless of the user being in a home or visiting MON, the routing mechanism allows the emergency transmission and the reaction system to identify the emergency messages issued by the machine-based devices, and the domain of the machine-based emergency reaction centers, so that a high priority connection can be set up for the machine-based devices emergency messages and the machine-based emergency events can be timely routed to one or more appropriate emergency reaction centers. The routing mechanism may be adopted to determine the methods and mechanisms required for emergency connection set up as well as data routing and transmission for the delivery of machine-based emergency service category values.

Whether the machine-based device issues emergency messages through a home MON or a visiting MON, the transmitting network end can always determine whether the message is an emergency message, the home MON of the machine-based emergency service category value or the MON able to handle the machine-based emergency category value (such as, a MON able to provide the machine-based emergency service category value, a MON to which the machine-based device is registered), and the domain or MON of the emergency event response center, as well as set up a high priority connection between the machine-based device and the emergency reaction center. The exemplary embodiments of the present disclosure may transmit expandable machine-based emergency service category values in the current 3GPP mobile communication network. Even if the MON does not handle the APN sent by the machine-based device, the exemplary embodiments of the present disclosure can also transmit the machine-based emergency service category value to other reaction centers that are able to handle the machine-based emergency notification to accommodate the diverse demands of warning services among machine-based communications.

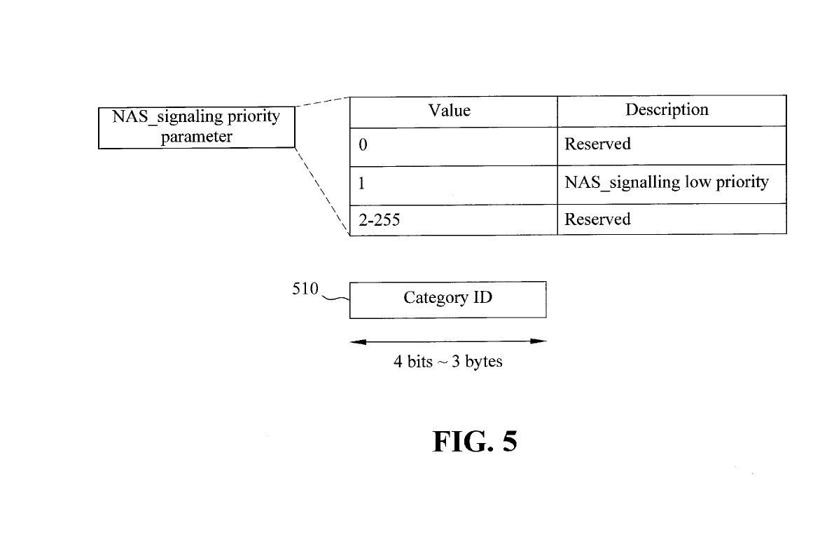

Accordingly, according to the routing procedure of emergency communications, the disclosure provides cross-network needed information for determining and routing machine-based emergency communications, methods of setting up a machine-based emergency connection, and methods of delivering machine-based emergency service category values. According to one exemplary embodiment of FIG. 5, the disclosure may set additional information to the machine-based device side, such as the use of a signaling priority parameter of a non-access stratum (NAS) configuration management objects (config MO), hereafter represented by the parameter NAS config MO but the scope is not limited to. The additional information may be set as a reference for the emergency processing procedures, such as referring by the method of machine-based emergency services category value. In FIG. 5, several bits in NAS config MO parameter are reserved. For example, in the reserved bits of the 2^{nd} bit to the 255th bit, a number of bits may be used as a category identity (ID) 510 of the machine-based emergency services category value, and the category ID 510 for example may have 4 bits to 3 bytes. The implementation of the machine-based emergency service category value described in FIG. 5 is only an exemplary embodiment in the disclosure, and a true scope of the disclosure is not limited to the exemplary implementation.

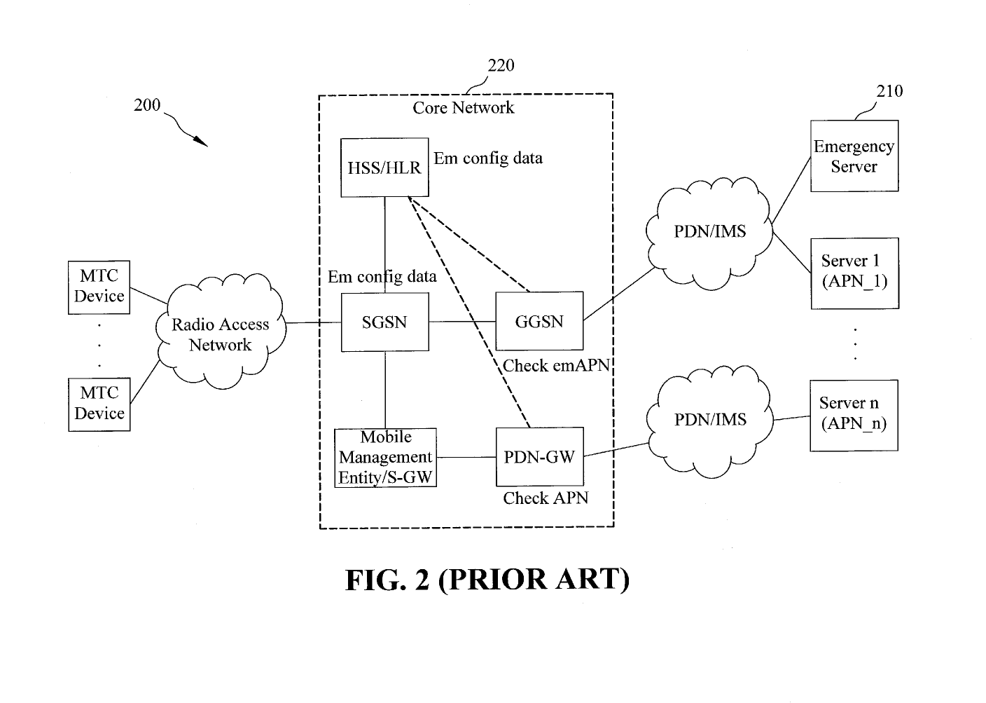

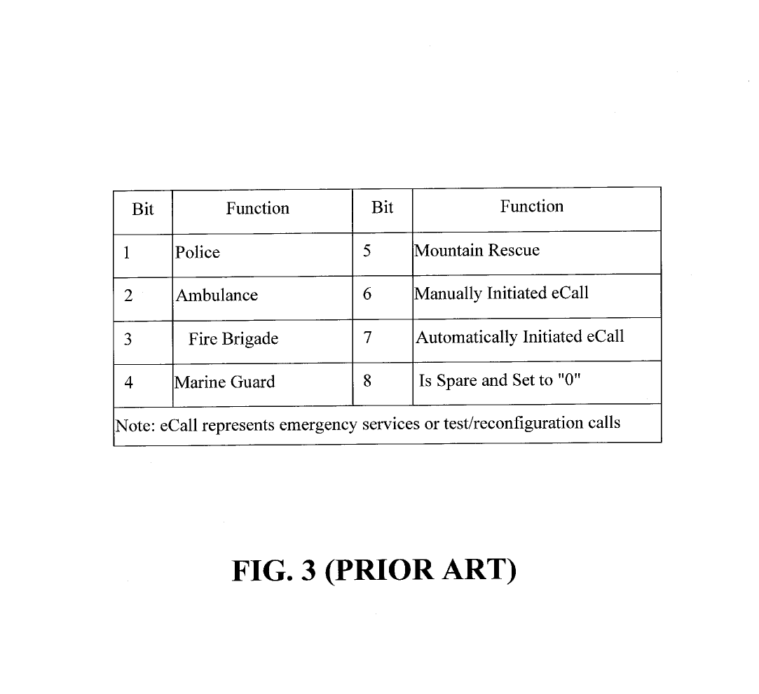

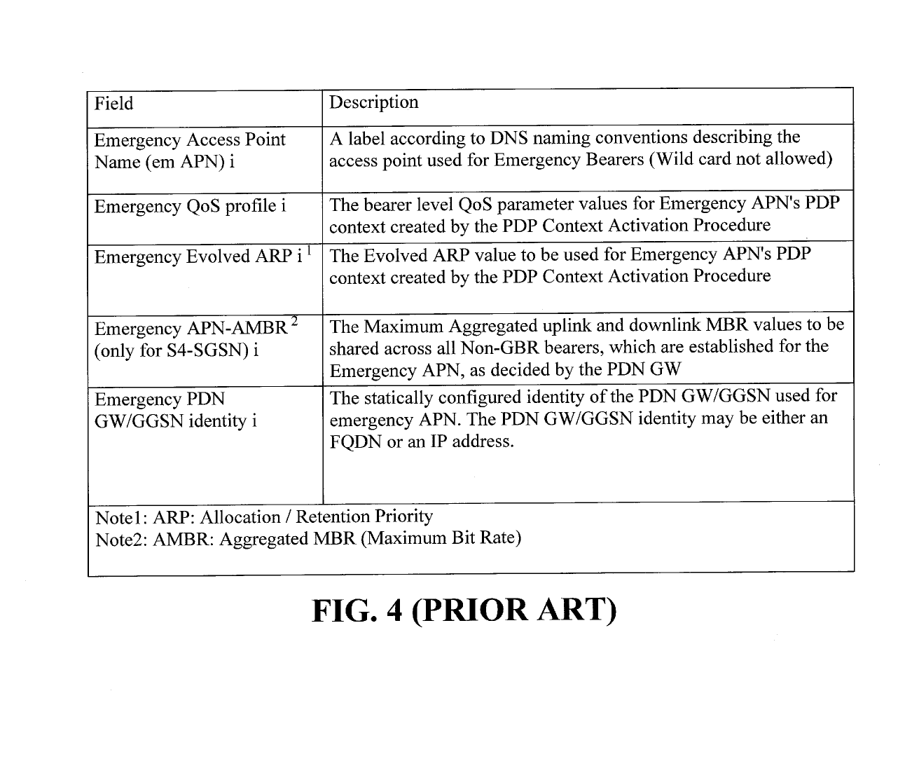

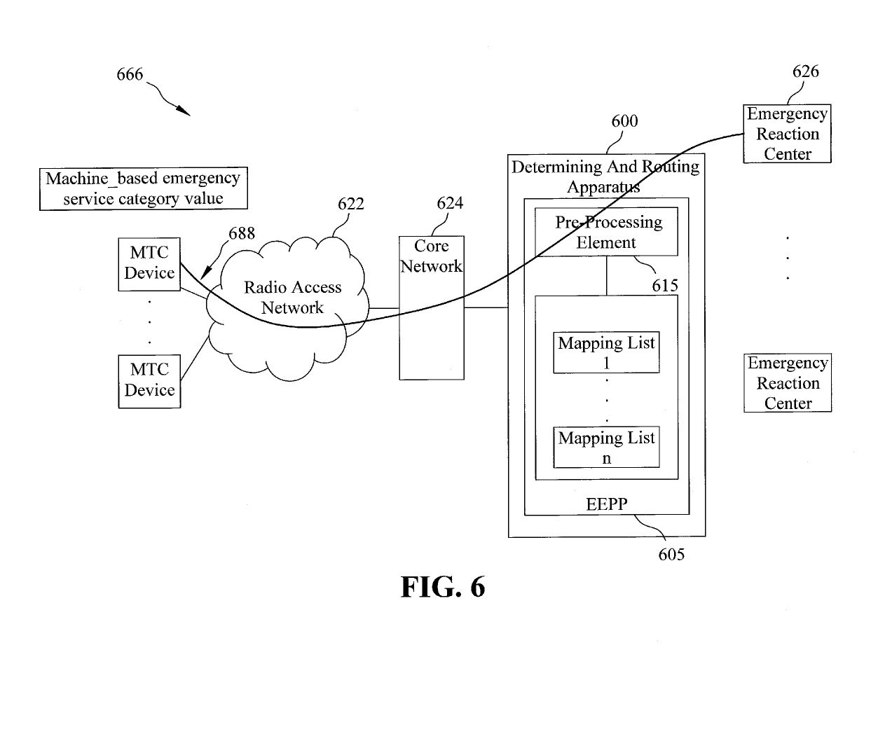

FIG. 6 shows a schematic view of a determining and routing apparatus for emergency communications, adapted to a machine-based communication network environment 666, according to an exemplary embodiment. The machine-based communication network environment 666 is such as but is not limited to the 3GPP communication network environment of FIG. 6. Yet another example is a PS-based domain services network environment, but the disclosed determining and routing apparatus may also work in a non-PS-based domain services network environment. The network environment, for example, may have one or more senders, one or more radio access networks 622, one or more core networks 624, and one or more emergency reaction centers 626, for example, the 3GPP emergency communication network architecture of FIG. 2. Refer to FIG. 6, the determining and routing apparatus 600 comprises an emergency event pre-processor (EEPP) 605, and the EEPP has a pre-processing element 615, where a MTC device is taken as an exemplary sender for illustration only.

For at least one machine-based emergency request issued by one or more MTC devices, pre-processing element 615 determines the at least one request and resolves at least one machine-based emergency services category values specified in a parameter, such as but not limits to the NAS Config MO parameter, and selects at least one emergency reaction center (emRC) capable of handing the at least one machine-based emergency services category values from one or more emergency reaction centers, such as emergency reaction center 626, and determines at least one routing path for transmitting corresponding emergency messages. The mapping information between the machine-based emergency services category values and the information of their corresponding emergency reaction centers may be maintained in one or more mapping lists, represented by mapping list 1 to mapping list n, where n is a positive integer. Each machine-based emergency services category value i may correspond to a mapping list i, respectively, where 1≦i≦n; and it may also use such as, but not limited to, a hierarchical scheme to establish and connect to one of the mapping lists. These mapping lists may be maintained in the elements of software, hardware, or firmware that have the function of storing information. These elements may be in the EEPP, or stand-alone.

The EEPP may be configured in a core network level or an application level. For example, EEPP is configured in an application level in FIG. 6. This configuration is only one exemplary embodiment of this disclosure, but the scope of this disclosure is not limited to this implementation. In the example of FIG. 6, the routing path 688 starts from an emergency request issued by a MTC device, through the at least one the radio access networks 622, the at least one core networks 624, the determining and routing apparatus 600 (including EEPP 605), then to the at least one emergency reaction center 626.

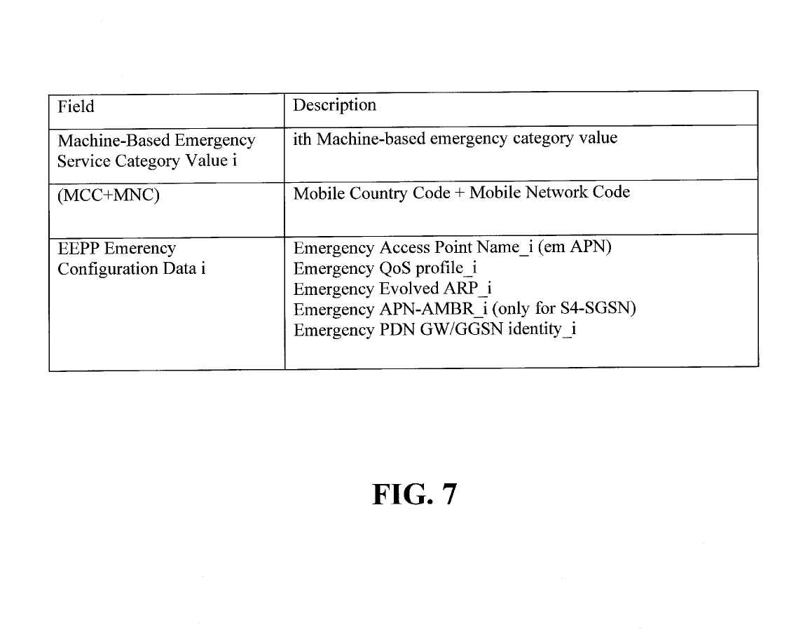

FIG. 7 illustrates each field of a mapping list i, according to an exemplary embodiment. In the exemplar of FIG. 7, the information stored in the mapping list contains at least one machine-based emergency service category value i, at least one MON ID, and the EEPP emergency configuration data i corresponding to the machine-based emergency service category value. The description of these fields may be described as FIG. 7. For example, the location information of the emRC corresponding to the machine-based emergency service category value includes an MON ID of the emRC or an address that is able to be used as a global domain identification. MON ID may be such as a mobile country code (MCC) added with a mobile network code (MNC). An address that is able to be used as the global domain identification may be such as an E.164 or FQDN format ID. In one exemplar, the EEPP emergency configuration data may contain at least emAPN, information of emergency QoS profile, emergency evolved assignment and retention priority (ARP), emergency APN-AMBR, emergency PDN GW/GGSN Identity, and so on.

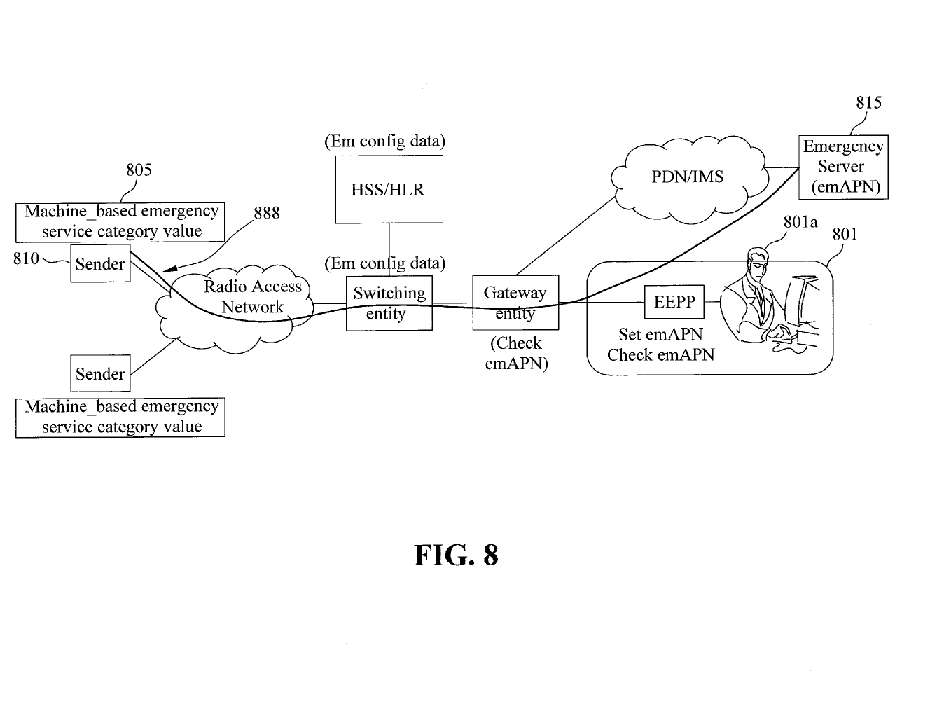

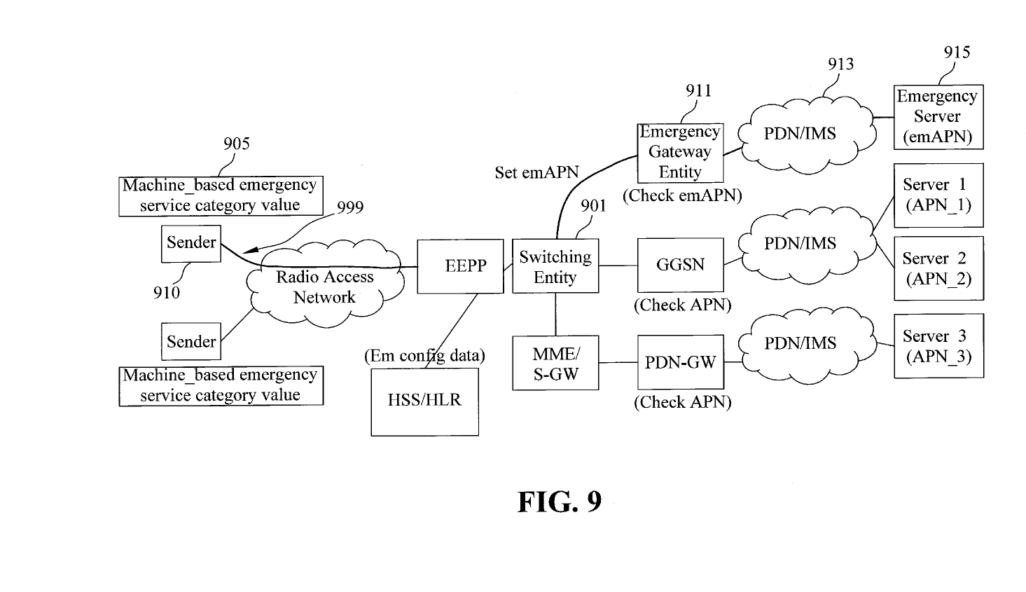

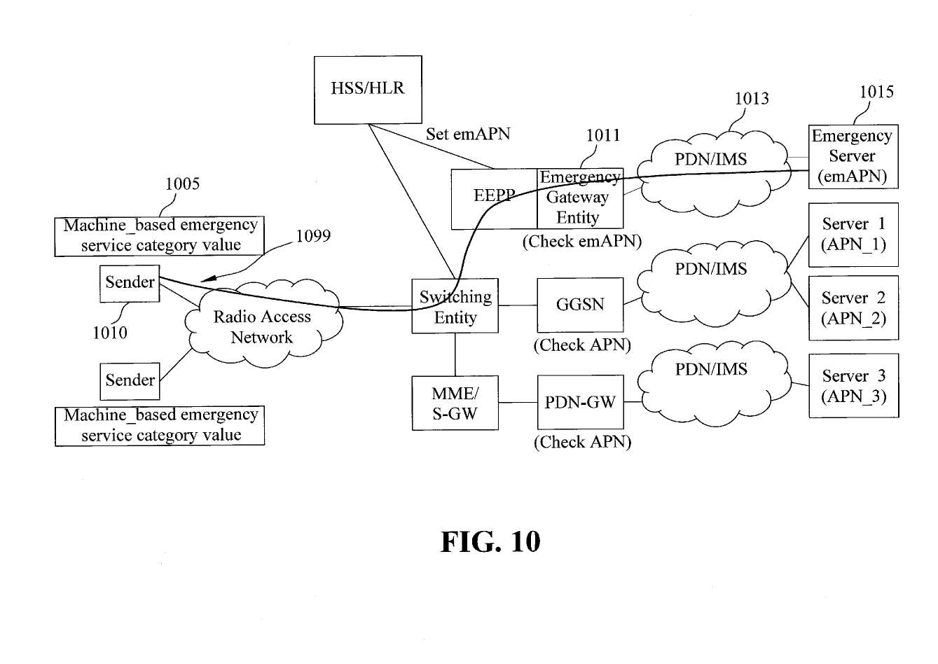

In the network environment, the EEPP may be configured with a variety of solutions, such as application level solution, network switching entity solution, and network gateway entity solution. The following further illustrates how to implement these solutions for determining and routing machine-based emergency events and messages. Wherein, FIG. 8, FIG. 9, and FIG. 10 illustrate the application level solution, the network switching entity solution, and the network gateway entity solution for EEPP configuration and routing path of machine-based emergency, respectively, according to exemplary embodiments.

Referring to the application level solution of FIG. 8, before a default emergency reaction center (Default_emRC) 801 handles an emergency request, such as before the person of emRC 801a handles this emergency request, the EEPP may be configured first and determines the emergency request, resolves the machine-based emergency service category value 805, and decides an emergency access point name (emAPN) capable of handling the machine-based emergency service category value 805, and information of the emRC such as location information of the emRC and so on. The routing path 888 of the emergency request starts from a sender 810 that issued an emergency request, and through at least one radio access network, at least one switching entity, at least one gateway entity, the EEPP, then to at least one emergency server 815 of the emAPN determined by the EEPP. More than one routing paths may also be designed to the delivery of the emergency request.

When a sender wants to issue an emergency request, an emergency indicator is set to provide the global domain broadband mobile network to determine the necessity of setting up an emergency connection and to set up a high priority emergency services connection between the sender and the emAPN; an emergency service category value is set for the communication network to determine the machine-based emergency event; emergency configuration data is set for the communication network to judge and decide at least one routing scheme and at least one routing path for the emergency request of the machine-based communications. For example, the disclosed EEPP may join the existing communication networks, and the emergency configuration data may be carried by the exiting parameter(s) of connection or service request to enhance the performance of routing the emergency message. In the exemplary solution of FIG. 8, after the sender sets the emergency indicator, the emergency service category value and the emergency configuration data, the switching entity may obtain the emergency configuration data from the received connection request parameter(s), and the gateway entity may check the information of the specified emAPN according to the received service request parameter(s).

Referring to the network switching entity level solution of FIG. 9, the EEPP may be configured before a switch entity 901 of the network. And, before the switching entity 901 process an emergency request, the EEPP first sets at least one emAPN capable of handling at least one emergency services category value 905 for the emergency request, and sets up a connection to an emergency server 915 of the emAPN through an emergency gateway entity 911. At least one routing path 999 of the emergency request starts from a sender 910 that issued an emergency request, and through a radio access network (e.g. GERAN/UTRAN, etc.), the EEPP, switching entity 901, emergency gateway entity 911, then through at least one emRC network such as the packet data network (PDN)/IP multimedia subsystem (IMS) 913, to at least one emergency server 915 of the emAPN determined by the EEPP.

In the exemplary solution of FIG. 9, after the sender 910 sets the emergency indicator, the emergency services category value, and the emergency configuration data, the EEPP first obtains the emergency configuration data according to the received connection request parameters, determines at least one emAPN capable of handling the machine-based emergency services category value and decides the emergency gateway entity 911, and sets up a connection from the emergency gateway entity 911 to the emergency server. The emergency gateway entity 911 checks information of the emAPN according to the service request parameters from the switching entity 901, and sets up a connection to the emergency server 915.

Referring to the network gateway entity level solution of FIG. 10, the EEPP may be configured before an emergency gateway entity 1011 of the network. And, before an emergency gateway entity 1011 processes an emergency request, the EEPP first determines at least one emAPN capable of handling machine-based emergency service category values 1005 for the emergency request, and sets up a connection to at least one emergency server 1015 of the emAPN through the emergency gateway entity 1011. At least one path 1099 for routing the emergency request starts from a sender 1010 that issues the emergency request, and through the radio access network, the switching entity, the EEPP, the emergency gateway entity 1011, then through the emRC network (such as the packet data network/IP multimedia subsystem 1013), to at lest one emergency server 1015 of the emAPN determined by the EEPP.

In the exemplary solution of FIG. 10, after the sender 1010 sets the emergency indicator, the emergency service category value, and the emergency configuration data, the switching entity of the 3GPP communication network routes the emergency request to the EEPP according to the received service request parameter(s). The EEPP first determines at least one emAPN capable of handling the machine-based emergency service category values and decides the emergency gateway entity 1011, and sets up the connection from the emergency gateway entity 1011 to the emergency server 1015. The emergency gateway unit 1011 checks the emAPN information according to the service request parameter(s) from the switching entity, and sets up a connection to the emergency server 1015.

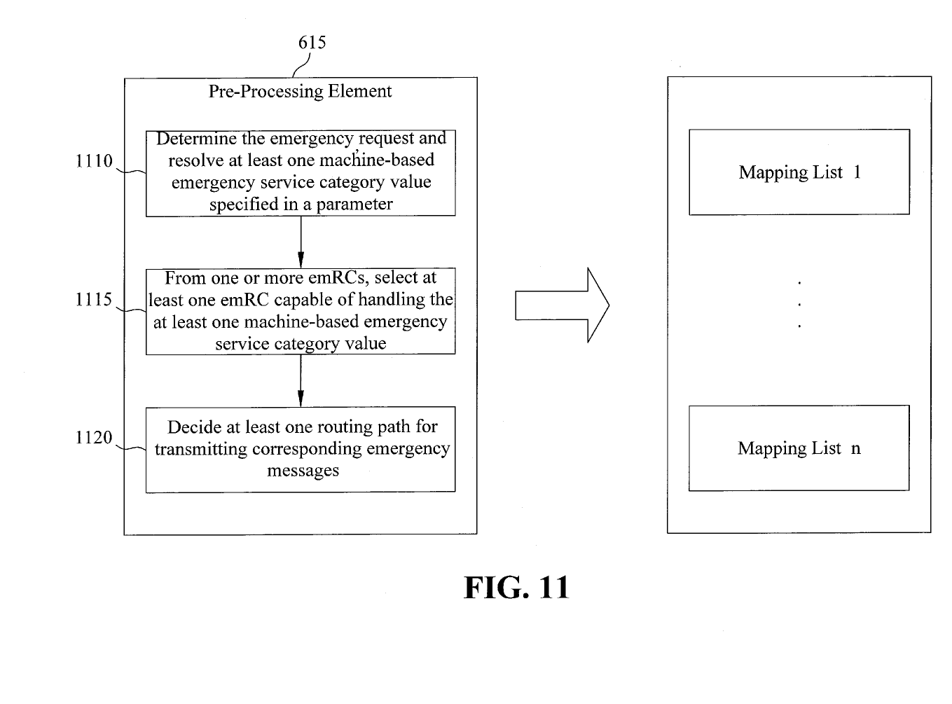

Accordingly, FIG. 11 illustrates the operation of a method for determining and routing emergency communications, according to an exemplary embodiment. The method may be adapted to a 3GPP communication network environment. Referring to FIG. 11, for an emergency request issued by one or more senders, the determining and routing method using a pre-processing element 615 for processing includes: determining the emergency request and resolving at least one machine-based emergency service category value specified in a parameter of the request (step 1110), and from one or more emRCs, selecting at least one emRC capable of handling the at least one machine-based emergency service category value (step 1115); and deciding at least one routing path for transmitting corresponding emergency messages (step 1120). And the determining and routing method uses one or more mapping lists for maintaining the mapping information between the machine-based emergency service category values and the emergency reaction centers. Each machine-based emergency services category value may correspond to a respective mapping list. An example of a mapping list is as shown in the FIG. 7, and is not repeated here.

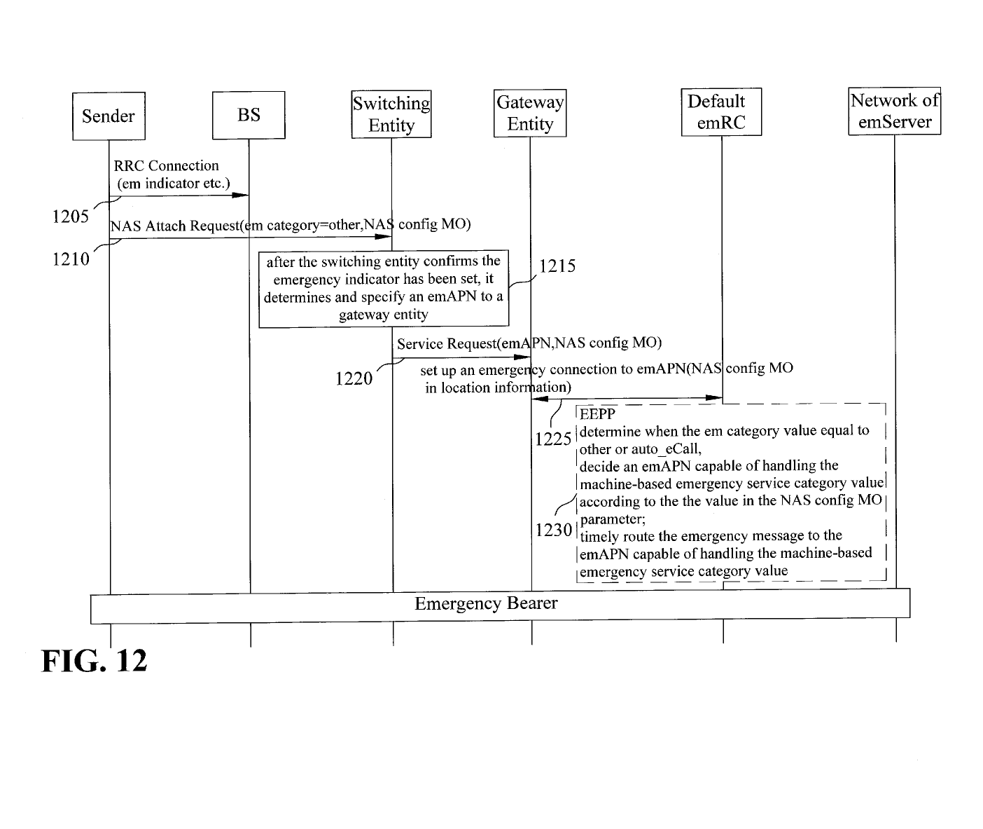

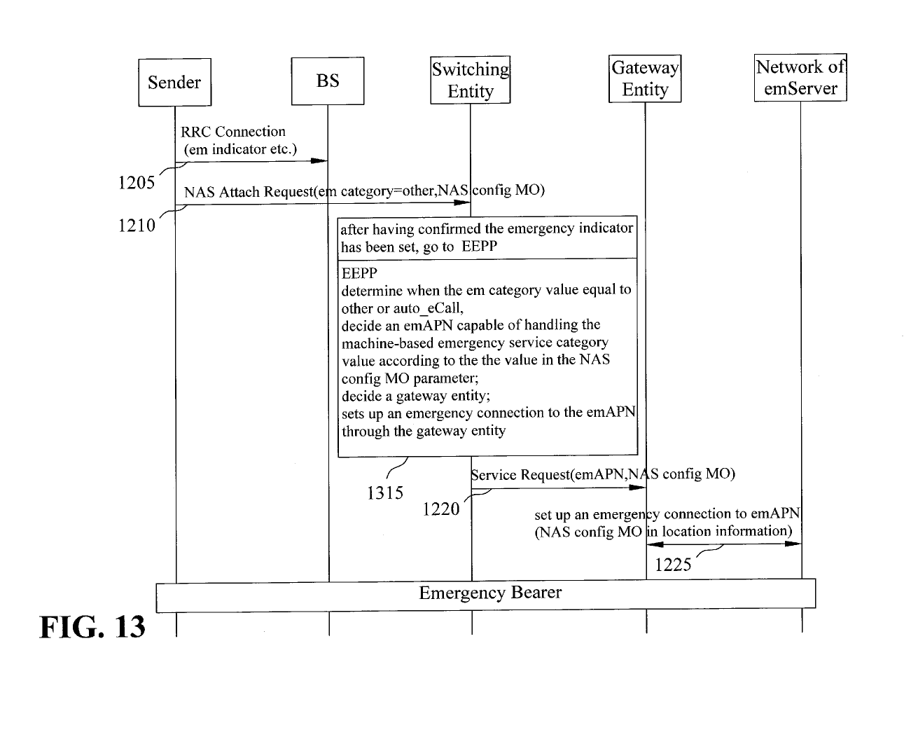

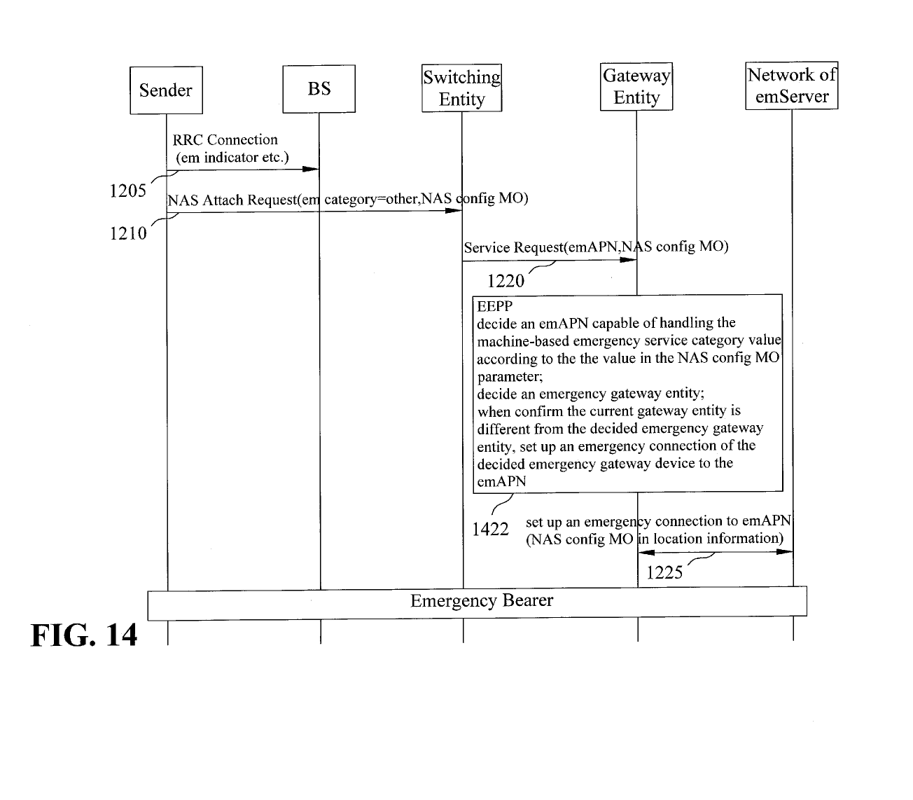

As mentioned earlier, the EEPP may include the pre-processing element 615. In the 3GPP communication network environment, the EEPP may be configured with the application level solution such as shown in FIG. 8, the network switching entity level solution such as shown in FIG. 9, and the network gateway entity level solution such as shown in FIG. 10. The following FIG. 12, FIG. 13, and FIG. 14 illustrate the machine-based emergency determining and routing procedures, when EEPP is configured with the application level solution, the network switching entity level solution, and the network gateway entity level solution, respectively, according to exemplary embodiments. In the disclosure, a sender may be a machine-based device such as a communication device of Internet of Things, a mobile device or a device with functions of a base station (BS), and so on, but only for the exemplary embodiments. The true scope of the disclosure is not limited to these implementations.

As previously mentioned, when a sender issues an emergency request, it first sets the emergency indicator for providing global domain broadband mobile networks to determine setting up an emergency connection. Referring to the operation flow of FIG. 12, the sender first sets an emergency indicator, such as shown in label 1205, sets up an emergency connection to a base station by issuing a radio resource control connection (RRC Connection). Then it issues such as a NAS attach request as shown in label 1210, to set up an emergency connection to a switch entity, and in the attach request, in addition to setting the existing emergency category value em category equals to the value representing other or auto_eCall, it may further set the information of the machine-based emergency service category value at the sender's side by using at least one parameter such as but not limited to, the NAS config MO parameter. The emergency category value auto_eCall may be adopted for the value representing automatic emergency services or test/reconfiguration calls.

In the current standard procedure, after the switching entity confirms the emergency indicator has been set, it may determine and specify an emAPN to a gateway entity, such as shown in step 1215. Then, according to the exemplary embodiment, the switching entity conveys the NAS config MO parameter information to the gateway entity by issuing a service request, as shown in the label 1220. According to the exemplary embodiment, the gateway entity checks the information of a specified emAPN to set up an emergency connection to the emAPN, as shown in the label 1225. The information of the NAS config MO parameter is included in the location information.

When the EEPP is configured with the application level solution, as previously shown in FIG. 8, the EEPP may be configured before a default emRC handles this emergency request. And first, the EEPP determines the emergency request, resolves the machine-based emergency service category value, and decides the emergency access point name (APN) capable of handling the machine-based emergency services category value. Therefore, the following may be seen from the step 1230 in FIG. 12. The EEPP is configured before the default emRC processes the emergency request, and when the EEPP determines the em category value equals to the value representing other or auto_eCall, it decides an emAPN capable of handling the machine-based emergency service category value according to the machine-based emergency service category value (in the exemplar, the value in the NAS config MO parameter), and timely routes the emergency message to the emAPN capable of handling the machine-based emergency service category value. The auto_eCall may represent automatic emergency services or test/reconfiguration calls.

When the EEPP is configured with the network switching entity level solution, as previously shown in FIG. 9, the EEPP may be configured before a switching entity of the network. And, before the switching entity processes an emergency request, first EEPP determines an least one emAPN capable of handling the machine-based emergency service category value for the emergency request, and sets up a connection to an emergency server of this emAPN through an emergency gateway entity. Therefore, the following may be seen from FIG. 13. The switching entity confirms the emergency indicator has been set, and goes to the EEPP to perform step 1315. In step 1315, when the EEPP determines the em category value equals to the value representing other or auto_eCall, decides at least one emAPN capable of handling the machine-based emergency service category value according to the machine-based emergency services category value (in the exemplar, the value in the NAS config MO parameter). And after having decided a gateway entity, the EEPP sets up an emergency connection to the emAPN through the gateway entity. After EEPP has completed step 1315, the switching entity processes the above action as shown in label 1220. The above-mentioned action shown in label 1225 is processed between the gateway entity and the network of an emergency server. The actions shown in label 1220 and label 1225 will not be repeated.

When the EEPP is configured with the network gateway entity level solution, as shown in FIG. 10, the EEPP may be configured before a gateway entity of the network, and before the gateway entity processes an emergency request, first the EEPP determines at least one emAPN capable of handling the machine-based emergency service category value for the emergency request, sets up a connection to an emergency server of the emAPN through the gateway entity. Therefore, the following may be seen from FIG. 14, after the gateway entity receives a service request issued by the switching entity, it goes to the EEPP to perform step 1422. In step 1422, the EEPP determines at least one emAPN capable of handling the machine-based emergency service category value according to the machine-based emergency service category value of the service request, (in the exemplar, the value in the NAS config MO parameter), and decides an emergency gateway entity. When the EEPP confirms the current gateway entity is different from the decided emergency gateway entity, it sets up an emergency connection of the decided emergency gateway device to the emAPN; when the current gateway device is equivalent to the decided emergency gateway entity, it sets up an emergency connection to the emAPN through the current gateway entity. And, the above-mentioned action shown in label 1225 is processed between the emergency gateway entity and the network of an emergency server, that is, the emergency gateway entity sets up an emergency connection to the emAPN capable of handling the machine-based emergency service category value according to the NAS config MO in the location information.

Therefore, the above exemplary embodiments of determining and routing machine-based emergency communications allows both home and visiting mobile operation networks to determine the network domains of the emergency reaction centers, and timely route emergency messages to appropriate reaction centers. The exemplary embodiments may determine the information of routing destinations and routing methods, may determine the needed delivery data items for each network device, may determine the network devices that maintain these information, may provide emergency service category values that may be dynamically expanded, and may set up a high-priority emergency communications connection mechanism for the machine-based devices and the corresponding emergency reaction centers, such as emergency servers, according to emergency services category values.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A determining and routing apparatus for emergency communications, adapted to a network environment, said determining and routing apparatus including an emergency event pre-processor (EEPP), and said EEPP comprising:
a pre-processing element, wherein for at least one emergency request issued by one or more senders, the pre-processing element determines the at least one emergency request, resolves at least one machine-based emergency service category value specified in a parameter according to the emergency request, selects at least one emergency reaction center (emRC) for processing the at least one machine-based emergency service category value, and decides at least one routing path to transmit one or more corresponding emergency messages.

2. The determining and routing apparatus as claimed in claim 1, wherein a mapping information between the at least one machine-based emergency services category value and the at least one emergency reaction center is maintained in at least one mapping list.

3. The determining and routing apparatus as claimed in claim 1, wherein said parameter is a non-access stratum signaling priority parameter of configuration management objects (NAS config MO).

4. The determining and routing apparatus as claimed in claim 2, wherein the maintained information of the at least one mapping list includes at least one emergency service category value, at least one mobile operation network (MON) identity, and EEPP emergency configuration data.

5. The determining and routing apparatus as claimed in claim 1, wherein in said network environment, said EEPP is configured with one of an application level solution, a network switching entity level solution, and a network gateway entity level solution.

6. The determining and routing apparatus as claimed in claim 5, wherein when said EEPP is configured with said application level solution, said EEPP is configured before a default emergency reaction center handles said emergency request, and said EEPP determines said emergency request, resolves said machine-based emergency services category, and decides an emergency access point name capable of handling said machine-based emergency service category and location information of emergency reaction center.

7. The determining and routing apparatus as claimed in claim 5, wherein when said EEPP is configured with said network switching entity level solution, said EEPP is configured before a switching entity in a network, and said EEPP sets at least one emergency access point name capable of handling the emergency service category value and information of the emergency reaction center capable of handling the emergency service category value.

8. The determining and routing apparatus as claimed in claim 5, wherein when said EEPP is configured with said network gateway entity level solution, said EEPP is configured before an emergency gateway entity in a network, and said EEPP decides at least one emergency access point name capable of handling said the emergency service category value and information of emergency reaction center capable of handling the emergency service category value.

9. A determining and routing method for emergency communications, adapted to a network environment, and said method comprising:
using an emergency event pre-processor (EEPP) to process at least one emergency request issued by one or more senders; wherein the processing by the EEPP includes:
determining the at least one emergency request, and resolving at least one machine-based emergency service category value specified in a parameter according to the emergency request;
selecting at least one emergency reaction center for processing the at least one machine-based emergency service category value; and
deciding at least one routing path to transmit one or more corresponding emergency messages.

10. The determining and routing method as claimed in claim 9, wherein a mapping information between the at least one machine-based emergency services category value and the at least one emergency reaction center is maintained in at least one mapping list.

11. The determining and routing method as claimed in claim 9, wherein said EEPP is configured with one of an application level solution, a network switching entity level solution, and a network gateway entity level solution.

12. The determining and routing method as claimed in claim 11, wherein said parameter is a non-access stratum signaling priority parameter of configuration management objects (NAS config MO).

13. The determining and routing method as claimed in claim 12, wherein when said EEPP is configured with said application level solution, said method includes:
in said network environment, a switching entity conveying information of said NAS config MO parameter to a gateway entity by issuing a service request; and
said gateway entity checking information of an emergency access point name (emAPN) to set up an emergency connection to an emergency reaction center.

14. The determining and routing method as claimed in claim 12, wherein when said EEPP is configured with said application level solution, said EEPP is configured before a default emRC processes the emergency request, and the processing by the EEPP includes:
determining when an emergency category value in a NAS attach request equals to a value representing other or automatic emergency services or test/reconfiguration calls, deciding an emAPN capable of handling the machine-based emergency service category value according to a value in the NAS config MO parameter, and timely routing at least one emergency message to the emAPN handling the machine-based emergency service category value.

15. The determining and routing method as claimed in claim 12, wherein when said EEPP is configured with said network switching entity level solution, the EEPP is configured before a switching entity in said network environment processes said emergency request, and the processing by the EEPP includes:
determining when an emergency category value in a NAS attach request equals to a value representing other or automatic emergency services or test/reconfiguration calls, deciding an emergency access point name (emAPN) capable of handling the machine-based emergency service category value according to a value in the NAS config MO parameter;
deciding a gateway entity; and
setting up an emergency connection to the emAPN through the gateway entity.

16. The determining and routing method as claimed in claim 15, wherein said method includes:
the switching entity issuing a service request conveying information of said NAS config MO parameter to the gateway entity; and
the gateway entity setting up the emergency connection to the emAPN through the information in the NAS config MO parameter.

17. The determining and routing method as claimed in claim 12, wherein when said EEPP is configured with said network gateway entity level solution, the EEPP is configured before a gateway entity in said network environment processes said emergency request, and after said gateway entity receives a service request conveying information of said NAS config MO parameter, and the processing by the EEPP includes:
deciding an emergency access point name handling the machine-based emergency service category value according to a value in the NAS config MO parameter;
deciding an emergency gateway entity; and
setting an emergency connection of a network to an emergency reaction center through the emergency gateway entity.

18. The determining and routing method as claimed in claim 17, wherein said method includes:
said emergency gateway entity setting up an emergency connection to said emAPN.
